(19) United States
(12) Patent Application Publication
(10) Pub. No.: US 2016/0132616 A1
(43) Pub. Date: May 12, 2016

(54) PLANNING A POWER DISTRIBUTION NETWORK

(71) Applicant: SIEMENS AKTIENGESELLSCHAFT, München (DE)

(72) Inventors: Jörg Hassel, Erlangen (DE); AMJAD MOHSEN, Erlangen (DE); JOHANNES REINSCHKE, Nürnberg (DE); MANFRED WEISS, Oberreichenbach (DE)

(73) Assignee: SIEMENS AKTIENGESELLSCHAFT, München (DE)

(21) Appl. No.: 14/897,158

(22) PCT Filed: Jun. 10, 2013
(86) PCT No.: PCT/EP2013/061893

§ 371 Date: Dec. 9, 2015

(51) Int. Cl. G06F 17/50; G06Q 50/06

(52) U.S. Cl. CPC G06F 17/5004; G06Q 50/06

(57) ABSTRACT

In a method for planning a power distribution network for an installation having a multiplicity of power consumers, time-dependent load profiles for the power consumers are created as a function of a change, over time, in inertial masses to be speeded up, slowed down and/or kept in motion using the power consumers, and time-dependent power profiles are created for the power consumers. A network plan is created for the power distribution network, and a time-dependent power profile is computed for the installation. Network components of the power distribution network are dimensioned as a function of the computed time-dependent power demands on the network components.

The invention relates to a method for planning a power distribution network for an installation having a multiplicity of power consumers. In particular, the invention relates to a method for planning a power distribution network for supplying electric power to electrically driven transport installations. By way of example, transport installations that have a multiplicity of electric motors are used for transporting material and/or people. Such transport installations may be luggage belts (for example at airports), belt conveyors (for example in opencast or underground mining), roller conveyors, chain conveyors, overhead conveyors and/or passenger transport installations (for example escalators, traffic routes, railways, suspension railways, elevators and/or cable cars).

Furthermore, the invention relates to a tool for planning a power distribution network for an installation having a multiplicity of power consumers.

To avoid the risk of the power distribution network collapsing under load conditions, it is necessary to avoid underdimensioning the power distribution network. Today, power distribution networks for large installations (such as airports and factories) are designed primarily on the basis of empirical values, i.e. by taking account of what are known as simultaneity factors. The simultaneity factors are proportioned by means of generous estimation of loads and an additional safety margin. Since the degree of uncertainty in the predicted load or in the simultaneity factors is very high, network planners tend to increase safety margins even further in order to avoid the power distribution network collapsing under peak load conditions. Therefore, electrical power distribution networks for buildings, particularly for industrial buildings or other commercially used buildings, are usually overdimensioned. The tendency for overdimensioning results primarily from a lack of detailed knowledge of the time-dependent loads that are connected to the power distribution network. Overdimensioning increases the overall costs for requisite network components such as outgoers, protective elements and cables/busbars. Consequently, in order to decrease investment costs for new power distribution networks, additional efforts are required that avoid overdimensioning such power distribution networks.

The invention is based on the object of providing a method for planning and dimensioning power distribution networks (particularly for buildings) that allows overdimensioning or underdimensioning of network components to be avoided. Furthermore, it is an object of the invention to provide a tool for planning and dimensioning power distribution networks (particularly for buildings) that allows underdimensioning or overdimensioning of network components to be avoided.

The invention achieves the object by providing a method for planning a power distribution network for an installation having a multiplicity of power consumers that comprises the following steps: creation of time-dependent load profiles for the power consumers, creation of time-dependent power profiles for the power consumers, creation of a network plan for the power distribution network, computation of a time-dependent power profile for the installation, and dimensioning of network components of the power distribution network taking account of the computed time-dependent power demands on the network components.

In this case, load profile is understood to mean a time characteristic of a mechanical load. The mechanical load is a mass that can be speeded up, slowed down or kept in motion by taking account of frictional losses. The mass that can be speeded up, slowed down and/or kept in motion comprises moving mechanical parts of the drive, the conveyable article carrier and also the payloads (conveyable articles and/or people to be conveyed). The moving mechanical parts of the drive are typically rotors in electric motors, gearbox parts and drive rollers. Conveyable article carriers are conveyor belts, pulling cables or conveying containers (such as transport dollies and conveying gondolas), for example. Conveyable articles include flight luggage, packages, raw materials and/or waste material, for example.

In this case, ‘time characteristic of the mass’ does not mean a locus for the mass in space, but rather means a change in the value of the physical variable mass in kg over time. The fact that a time characteristic for the mass is considered here is based on the fact that, in contrast to many other mechanical systems, a transport system requires account to be taken of the special feature that the mass that can be speeded up, slowed down or kept in motion by taking account of frictional losses can change continually on the basis of a use of the conveyable article carrier (for example on the basis of current loading/unloading of items of luggage onto/from the conveyor belt or entry or exit to/from a moving walkway).

In this case, power profile is understood to mean a time characteristic for the electrical power drawn by the electrical consumers (for example drive motors for belt sections). If there is also provision for recovery (recuperation) of energy, for example when a belt section is slowed down, the electrical power drawn by the respective electric drive may also be intermittently negative.

Accordingly, the tool according to the invention for planning a power distribution network for an installation having a multiplicity of power consumers comprises the following components: a load computation tool for producing load profiles for the power consumers, a power draw computation tool for producing time-dependent power profiles for the power consumers and a power profile for the installation, and a network dimensioning tool for dimensioning and selecting network components of the power distribution network.

A concept of the present invention can be considered to be that of combining a plurality of planning steps and/or a plurality of planning tools with one another in order to allow time-efficient and cost-efficient planning with an error-free result that is optimized according to design criteria.

Mechanical load profiles and electrical power profiles can be obtained by combining two simulation models. One of the two simulation models can be a digital model of the device to be supplied with power, for example, which model is usually used for initial analyses of fundamental features of the device to be supplied with power, such as turnover and efficiency. The other simulation model can be an electromechanical model, for example, that considers physical dimensions and electromechanical parameters of the installed network components, such as the type of motors, drivers, converters and controllers. Network components of an (electrical) power distribution network are, in principle, each dimensioned according to that demand (i.e. a maximum power to be transmitted or a maximum current to be conducted, for example) that the respective network component is intended to withstand and still not be destroyed in the most adverse operating instance.

One development has provision for the sequence of the first four method steps to be repeated for at least two different consumption scenarios and the results for the different consumption scenarios to be taken into account in the step of dimensioning the network components. This means that it is possible to ensure that the components of the power distribution network have sufficient efficiency in each of a plurality of different consumption scenarios.

A further development has provision for the sequence of the method steps to be repeated for at least two different network configurations and then one of these network configurations to be selected on the basis of an outlay criterion. This means that it is possible to minimize outlay for design of the power distribution network.

It may also be expedient if the dimensioning of the network components takes account of safety margins. This means that it is possible to reduce the risk of overload and of subsequent failure of the power distribution network on the basis of erroneous assumptions.

Furthermore, it is advantageous if the power profiles are augmented with information about powers, short circuit current levels, energy budgets and/or voltage drops. This provides bases for more comprehensive planning of the power distribution network.

One development of the tool provides for the tool to comprise an interface converter for matching an interface protocol of the load computation tool to an interface protocol of the power draw computation tool. This means that available load and power drawer computation tools can be used for an integrated tool (for planning a power distribution network) without needing to match their own interfaces to one another.

A further development of the tool provides for the interface converter to be prepared to split load profiles in order to meet input interface demands from the power draw computation tool. This means that an available power draw computation tool can be used for an integrated tool (for planning a power distribution network) even if the power draw computation tool is unable to accommodate a load profile produced by the available load computation tool in one step.

The invention is explained in more detail with reference to the appended drawings, in which:

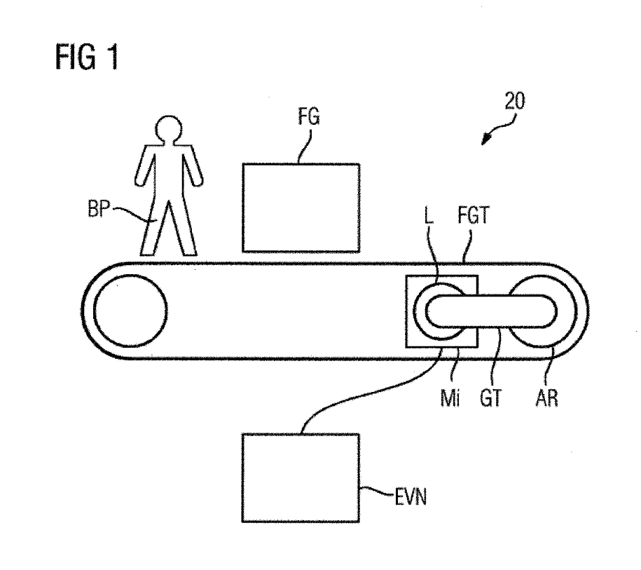

FIG. 1 schematically shows a basic design of a transport installation;

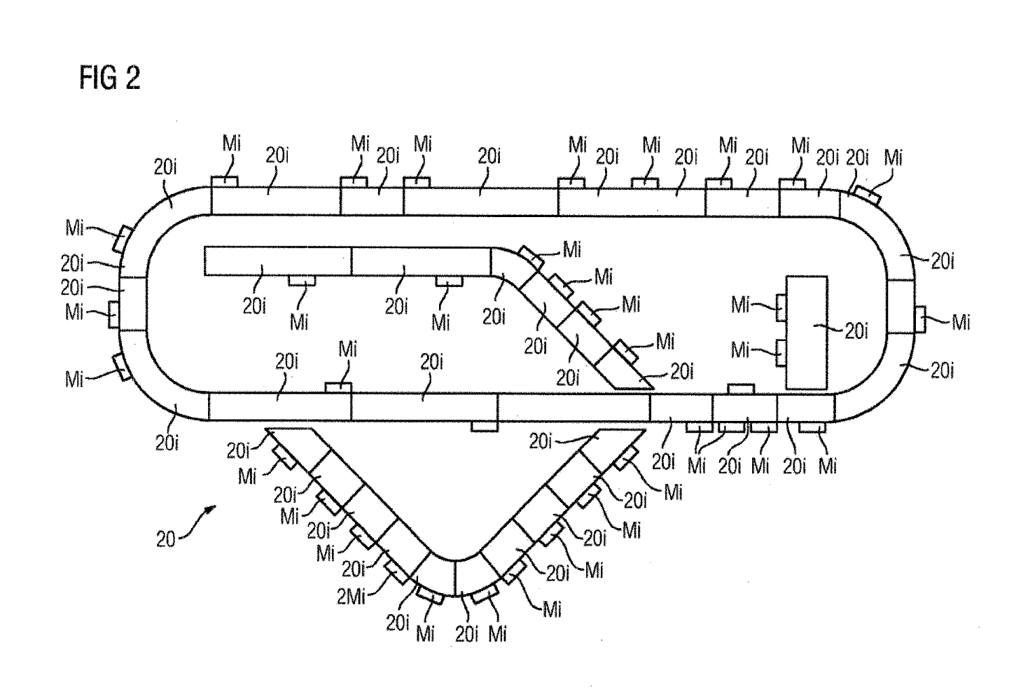

FIG. 2 schematically shows a luggage transport system for an airport;

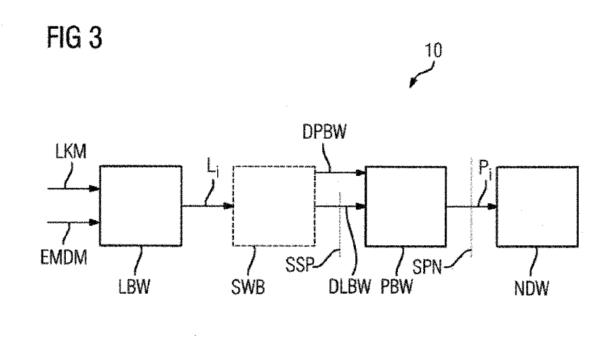

FIG. 3 schematically shows an overall view of a tool for planning a power distribution network;

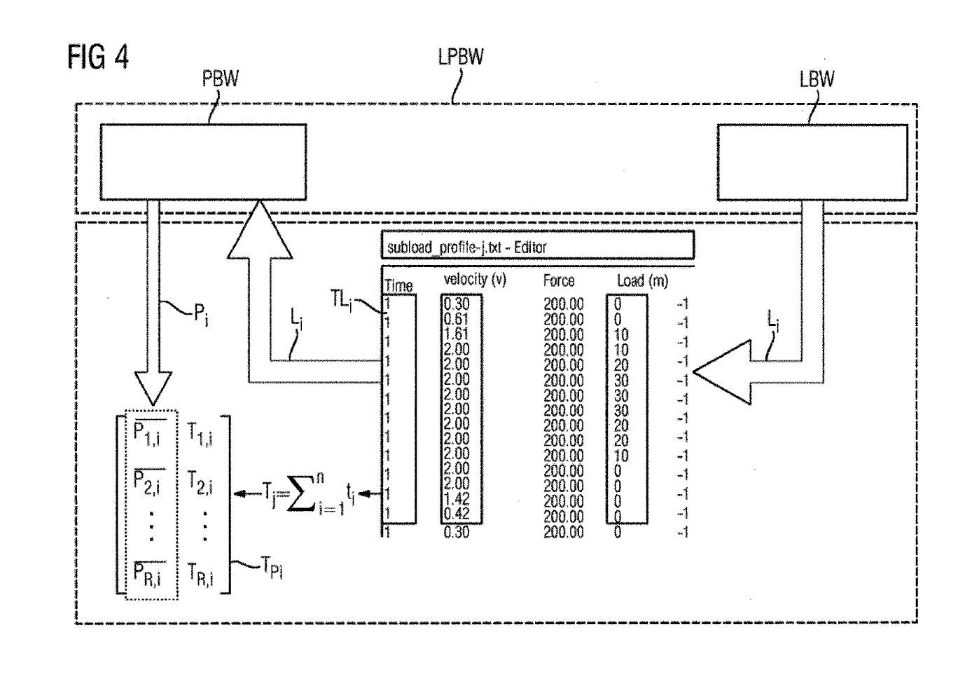

FIG. 4 schematically shows a flow of data for the construction of a power profile;

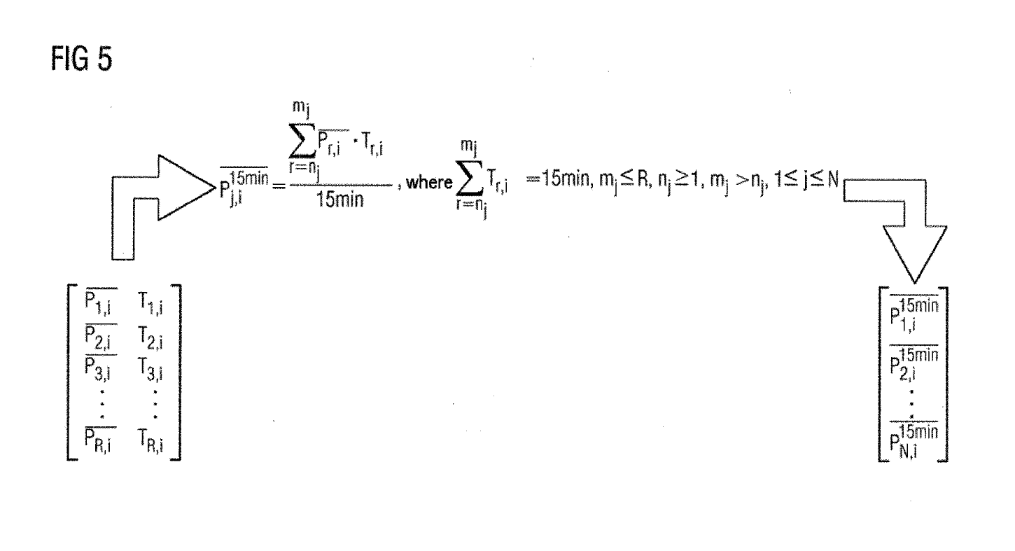

FIG. 5 schematically shows construction of power vectors;

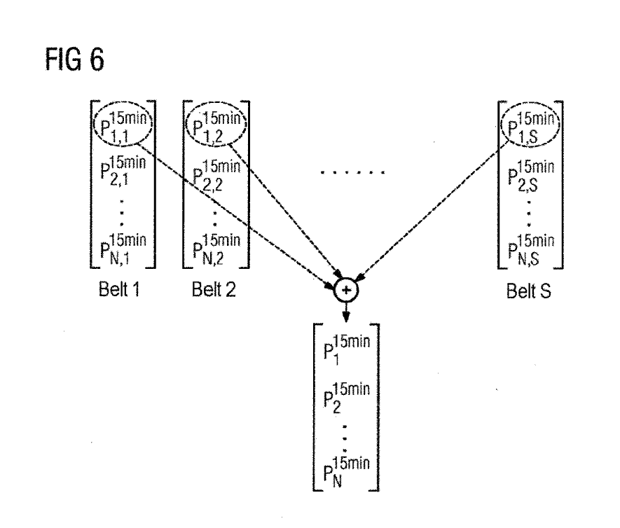

FIG. 6 schematically shows summation of power vectors for a plurality of conveyor belt sections;

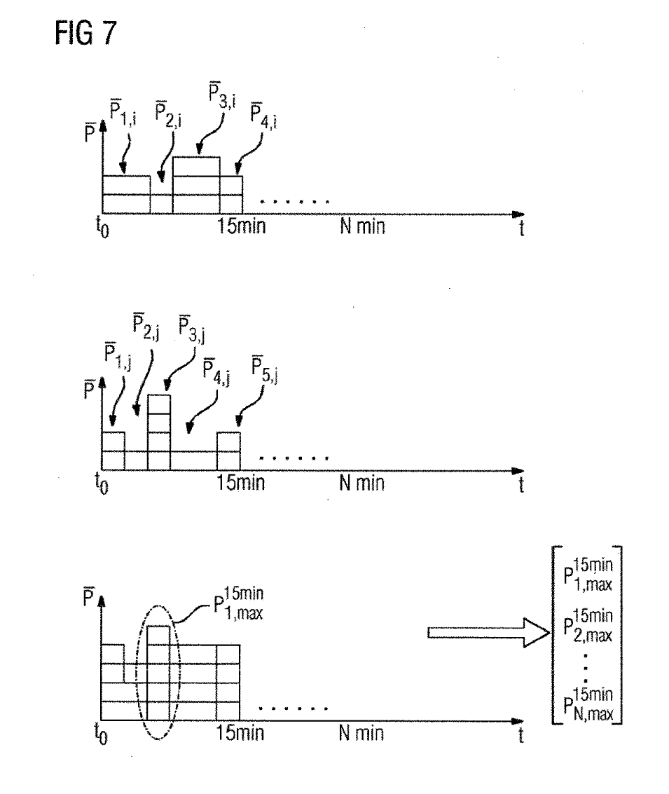

FIG. 7 schematically shows computation of power vectors for maximum powers of the installation using the example of addition of the power vectors from two belt sections;

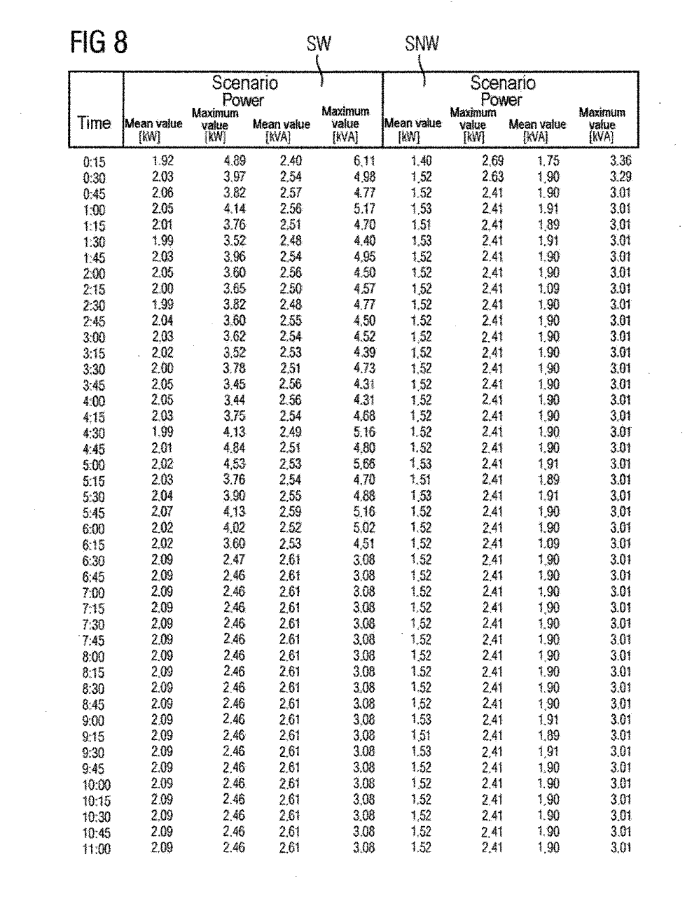

FIG. 8 schematically shows an example of a power profile of the installation;

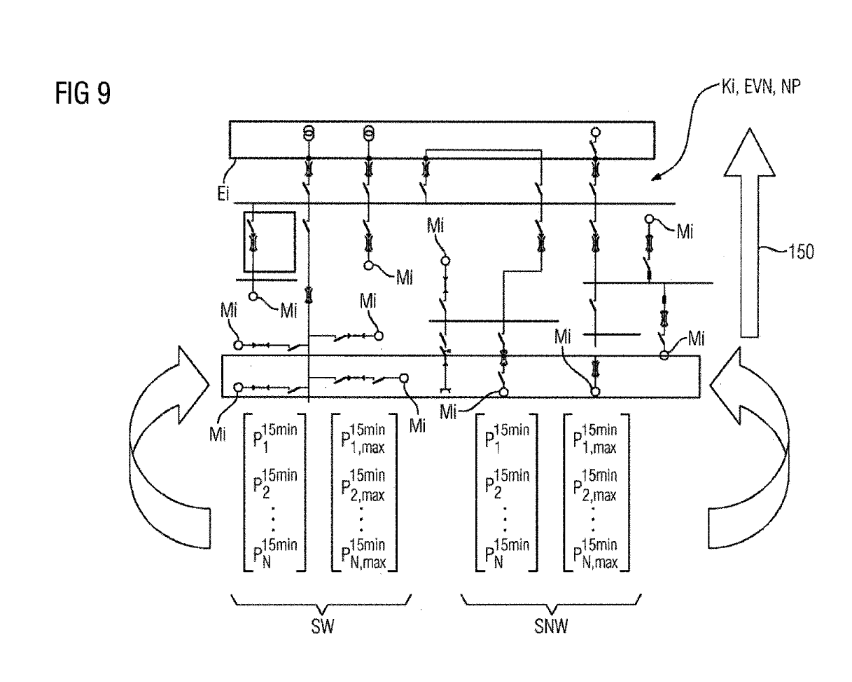

FIG. 9 schematically shows the step of planning a power distribution network, optimized on the basis of planning criteria, for an overall installation;

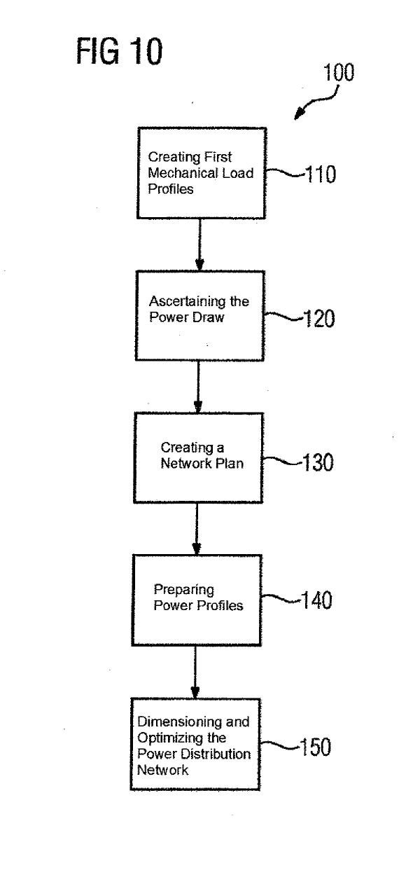

FIG. 10 schematically shows a course of a method for planning a power distribution network.

The exemplary embodiments outlined in more detail below are preferred embodiments of the present invention.

FIG. 1 shows a basic design of a transport installation 20 for transporting material and/or people. The transport installation 20 has a multiplicity of electric motors Mi. The electric motors Mi can be used (by taking account of frictional forces and frictional losses) to speed up, slow down and/or keep in motion objects that need to be moved (rotors L of electric motors Mi, gearbox parts GT, drive rollers AR, conveyable article carriers FGT, conveyable articles FG and people that need to be conveyed BP). The power for speeding up the objects to be moved L, GT, AR, FGT, BP is provided as electrical power by means of the electrical power distribution network EVN and is converted into mechanical power by means of the electric motors Mi. By speeding up the objects to be moved, L, GT, AR, FGT, BP, electrical energy (which is supplied to the electric motors Mi via the power distribution network EVN) is converted into kinetic energy.

Since the highest possible efficiency factor is sought in transport installations 20, the drive parts L, GT, AR and/or conveyable article carriers FGT to be moved are normally mounted with as little friction as possible (for example by means of roller bearings WL). This means that the forces that need to be applied in order to speed up the inertial masses (or moments of inertia) L, GT, AR, FGT, BP normally significantly outweigh the frictional forces that need to be overcome. This means that (besides the absolute value of the demanded acceleration) the absolute value of the masses to be speeded up (in kg) is of critical significance for a maximum power requirement of the transport installation 20 that the electrical power supply system EVN needs to supply with electrical energy.

In the case of transport installations 20, the mass to be speeded up L, GT, AR, FGT, BP is a particularly significant parameter also, inter alia, because (in comparison with many other mechanical systems) in the case of a transport installation 20 it is necessary to take account of the special feature that the mass L, GT, AR, FGT, BP that needs to be speeded up, slowed down or, taking account of frictional losses, kept in motion can continually change on the basis of a payload FGT, BP of the transport installation 20 (i.e. on the basis of present loading and/or unloading of conveyable articles FG onto/from the conveyable article carrier FGT and/or on the basis of entry or exit to/from the conveyable article carrier FGT by people who are to be conveyed BP). In this case, the mass of drive parts L, GT, AR that need to be moved and the mass of the conveyable article carrier FGT that needs to be moved normally remain unchanged, whereas the mass of the conveyable articles FG and of the people who need to be conveyed BP changes over time.

The luggage transport installation 20 shown in FIG. 2 comprises a plurality of conveyor belt sections 201 having a multiplicity of electric motors Mi. The index i is a running index that denotes a consumer. Typically, each conveyor belt section 20i has precisely one electric motor Mi as a consumer.

In the present example, i therefore also typically denotes precisely one conveyor belt section 20i. The electric motors Mi are started in some cases simultaneously and in some cases at different times, so that high starting currents for the electric motors Mi when the electric motors Mi are started up occur in some cases simultaneously and in some cases in different periods. Since all the electric motors Mi are not always operated simultaneously, the currents in the electric motors Mi also add up only in part during normal operation. In order to take account of the increased current draw when the electric motors Mi start, not only the real powers but also apparent powers are ascertained. From a cumulation of mechanical load profiles, a power profile is computed.

FIG. 3 shows an overview of a tool 10 for dimensioning, planning and optimizing electrical power distribution networks EVN. The tool 10 comprises a load computation tool LBW for producing mechanical load profiles Li, a power draw computation tool PBW for producing power profiles Pi and a network dimensioning tool NDW for dimensioning and selecting network components Ki (see FIG. 9). Arranged between the load computation tool LBW and the power draw computation tool PBW there can be a software bridge SWB that is used to split mechanical load profiles Li in order to meet demands of the power draw computation tool PBW.

The first component LBW is a tool for producing mechanical load profiles Li. As input data, the load computation tool LBW is supplied with a digital model LKM of the installation 20 and with an electromechanical model EMDM of the installation 20.

The digital model LKM comprises manually, semi-manually or fully automatically created layout and configuration information. In the present example of application, the layout and configuration information can comprise, by way of example, a geometry of the conveyor belt sections 20i (for example length and width in m), luggage turnover data (for example in kg per h), luggage density (for example in kg per belt section length in m) and a mass m to be speeded up (see column header in table in FIG. 4) for the respective belt section 20i and the drive parts thereof (for example in kg).

By way of example, the electromechanical model EMDM of the installation 20 can comprise details of the motors, starters, drivers and input/output network components that are to be used.

By taking account of these input data LKM and a digital electromechanical model EMDM of the final nodes Mi, the load computation tool LBW ascertains simulated mechanical load profiles Li for the final nodes Mi (consumers). By way of example, the mechanical load profiles Li can reproduce the starting behavior of electric motors Mi, which is described, by way of example, by means of one table TLi per electric motor Mi that has the following columns: time, velocity, force and loading of the conveyor belt section 20i.

In order to provide the network planner with additional details about the power requirement Pi as a function of time t and load Li, the following two scenarios SW, SNW are considered: a first scenario SW for normal working days and a second scenario SNW for non-working days.

The second component is an interface converter, which is subsequently referred to as a software bridge SWB and can be produced in Matlab®.

The third component is a tool PBW for determining the power draw Pi of the installation components 20i. By way of example, the output from the third component PBW can be a table TPi in which, by way of example, every second there is an associated power value Pi averaged over the respective second.

If there is no load and power draw computation tool LPBW available that can compute both a mechanical load profile Li for the electrical consumers Mi and the associated power draw Pi thereof then a first computation tool LBW for computing the mechanical load profiles of the electrical consumers Mi can be combined with a second computation tool PBW for computing the associated power draws Pi.

If the power draw computation tool PBW cannot accommodate sufficiently large dynamic load profiles Li, as are produced by the load computation tool LBW, the mechanical load profile Li can be split by means of a software bridge SWB in order to meet the demands of the power draw computation tool PBW.

The simulation tool LBW for computing the mechanical load profile of the electrical consumers Mi is subsequently referred to as a load computation tool LBW. A suitable load computation tool LBW is the ‘Plant Simulation’ tool from Tecnomatix®/Siemens®, for example.

The simulation tool PBW for computing the power draw Pi is subsequently referred to as a power draw computation tool PBW. A suitable power draw computation tool PBW is SIZER®, for example.

A digital model of the installation 20 is first of all simulated in a load computation tool LBW in order to obtain the mechanical load profiles Li of the installation 20 or of the individual electrical consumers Mi thereof. The key variables (defined on the basis of physical concepts) that influence the energy consumption are recorded as a function of time t in order to produce a first mechanical load profile Li. By way of example, key variables such as velocity, load (mass to be speeded up) and acceleration for each conveyor belt section 20i of an airport are recorded as a function over time t. The model of the installation 20 is produced using planning and configuration information that is usually provided by planning engineers. The load computation tool LBW is extended by a new method in order to present the variables of interest as time-dependent functions. Usually, new installations 20 are simulated at early design stages in order to rate and optimize throughput and efficiency. Therefore, a digital model of the installation 20 is usually available in the load computation tool LBW used. The mechanical load profiles Li are then analyzed and the format is converted by a software bridge SWB (which can be produced using Matlab®, for example). The format conversion is performed in order to meet the input interface demands of the power draw computation tool PBW.

The load computation tool LBW produces first time-dependent mechanical load profiles Li. The power draw computation tool PBW then computes (on the basis of electromechanical models of the electrical consumers Mi) the time-dependent power draw Pi that is connected to the first mechanical load profiles Li.

The time-dependent mechanical load profiles Li obtained in the first step 110 (see FIG. 10) are prepared and repeatedly supplied by means of the software bridge SWB to the power drawer computation tool PBW together with the corresponding electromechanical model EMDM of the intended part of the installation 20. The electromechanical model is written to a text file that is then converted into corresponding commands in the power draw computation tool PBW in order to produce a model with time-dependent mechanical power profiles Pi in a second step 120 (see FIG. 10).

The conversion of the text file into commands for the power draw computation tool PBW is effected by means of a software bridge SWB, which is an interface converter that has been developed for this purpose in order to automate the method 100. Whenever the power draw computation tool PBW is called, the software bridge SWB forwards two files. The first file DPBW contains all parameters relevant to the power draw computation tool PBW that are needed in order to describe the electromechanical system (motor type, starters, drivers, input/output network components, etc.). The second file DLBW is the mechanical load profile Li or a portion thereof that is produced by the load computation tool LBW. The power draw computation tool PBW is repeatedly called when the magnitude of the dynamic load profile Li is greater than the maximum magnitude that the power draw computation tool PBW can accommodate. Besides power ascertainments, it ascertains the influence of oscillations on the supply.

The results from the power draw computation tool PBW are returned to the software bridge SWB in the form of a Microsoft® document file. The ascertained power Pi for each mechanical load profile Li is then stored in power tables TR by the software bridge SWB together with the period of time for the corresponding mechanical load profile Pi. These power tables TPi are then used to construct the power profiles Pi that are needed by the network dimensioning tool NDW, as will now be described. The primary purpose of the power draw computation tool PBW is to ascertain the power draw P20 in the installation 20 using realistic and proven electromechanical models of the electrical consumers Mi (such as motors used, conveyor belt types, drive systems and electrical converters). The added value of using the power draw computation tool PBW is that the mechanical load profiles Li obtained through simulation of the installation 20 are used in the load computation tool LBW together with the aforementioned electromechanical model of the installation 20 in order to obtain realistic assumptions of the power draw P20.

In a third step 130 (see FIG. 10), a network plan is created for the power distribution network EVN. Some or all of this step 130 can also take place before the first 110 or before the second 120 step.

The power tables TPi obtained in the fourth step 140 (see FIG. 10) are used in order to construct power profiles Pi for 15-minute steps, which power profiles are needed by the network dimensioning tool NDW. These power profiles Pi provide the average Pi_ and maximum Pimax power draws in 15-minute steps for one day for the entire installation 20. First of all, the averaged power profile Pi is prepared in 15-minute steps for each electrical consumer Mi of the installation 20. The averaged power profiles Pi in 15-minute steps for the individual electrical consumers Mi are then added to one another in order to produce a single power profile P20 for the entire installation 20. The computation of the maximum power profile P20max of the entire installation in 15-minute steps first of all requires the computation of a power curve PK20 (power draw as a function of time t) for the entire installation 20. The power curve PK20 shows the instantaneous power draw of the installation 20 as a function of time t. On the basis of this power profile P20, the maximum power profile is constructed in 15-minute steps by searching for the (instantaneous) maximum power draw value in 15-minute intervals.

FIG. 4 shows a flow of data between three components of the LBW, PBW, NDW tool 10 for planning a power distribution network EVN.

FIG. 5 shows how power subprofiles Pr,i averaged over quarters of an hour are summed to form aggregated power values P20_{n,i} averaged over quarters of an hour, for a respective single belt section 20i.

FIG. 6 shows how power draw values Pi averaged over quarters of an hour are summed to form aggregated power values P20_{n,i} averaged over quarters of an hour for an entire installation 20 that comprises a plurality of conveyor belt sections 20i.

The graph shown at the top of FIG. 7 shows an example of a power profile Pi for an i-th conveyor belt section 20i that has been created by means of the tool 10 according to the invention. The graph shown in the middle of FIG. 7 shows an example of a power profile Pj for a j-th conveyor belt section 20j that has been created by means of the tool 10 according to the invention. The graph shown at the bottom of FIG. 7 shows an example of a power profile P20_{n,max} for an installation 20 with maximum values of the power that are averaged over quarters of an hour.

FIG. 8 shows an example of a power profile for the installation 20 with respective mean values and maximum values for the real and apparent powers, specifically for a scenario SW for a working day and a scenario SNW for a non-working day in each case.

FIG. 9 outlines step 150 in the planning of an electrical network EVN of an entire installation 20, which electrical network is optimized according to planning criteria (for example cost minimization objectives; quality objectives, availability objectives). On the basis of each of the two scenarios SN, SNW, a single power profile P20 is created for the entire installation 20. The power profiles P20 assist the network planner in defining power values P20m_averaged over quarters of an hour and upper limits P20max for the power requirement P20. The simulated power profiles P20 and the safety margins SZi defined below are transferred to a network dimensioning tool NDW for planning power distribution networks EVN (for example to SIMARIS®).

The network dimensioning tool NDW is then used to dimension the power distribution network EVN from destination nodes Mi (such as motors) to the feed locations Ei using the simulated power profiles Pi of the destination nodes Mi. Apart from the fast and efficient selection and conditioning of the required network components Ki, the network dimensioning tool NDW computes many further pieces of information Ii that are useful for network planning 140. These may be short-circuit currents, flows of power, voltage drops and envelopes for ratings for the selection of network components Ki or for sensitivity analyses, for example. All of these further pieces of information Ii are computed on the basis of the simulated mechanical load profiles Li (instead of conventionally using coarse estimations of simultaneity factors in conjunction with generously proportioned safety margins).

The power profiles Pi needed by the network dimensioning tool NDW are provided by a simulation tool LBW, PBW for electrical consumers Mi and loads Li. The simulation tool LBW, PBW for electrical consumers Mi and loads Li should be able to compute both the functionality of the respective electric machine Mi (such as throughput) and the associated power draw Pi thereof.

In this case, a further interface SPN is provided in order to render the network dimensioning tool NDW able to use the aforementioned power profiles Pi. The network dimensioning tool NDW then automatically designs the power distribution network EVN according to IEC standards and ascertains a safe and reliable solution. The output from the network dimensioning tool NDW is a list of the required network components Ki (typically these are only network components from Siemens®) and of the associated costs. When using the network dimensioning tool NDW, it is also possible to perform computations for different network designs. This allows ascertainment of the design having the lowest costs.

The primary advantage is that the network dimensioning tool NDW is rendered able to ascertain an inexpensive, reliable and realistic solution for a power distribution network EVN that is based on realistic, simulated power profiles Pi because realistic operating parameters and design information are combined with electromechanical models of the installation 20 in order to prepare the power profiles Pi. This makes planning of the power distribution network EVN realistic, which avoids overdimensioning. This decreases costs by decreasing the magnitude of the required network components Ki and possibly also the number of network components Ki. In addition, an availability of the entire power distribution network EVN is increased by virtue of the network dimensioning tool NDW being rendered able to ascertain the required safety margins SZi more precisely. Furthermore, the best suited network components Ki are selected. Another advantage that is achieved by concatenating different models and tools LBW, PBW, NDW that have been developed for different purposes in order to provide a single tool environment 10 in which the power distribution network EVN is dimensioned, electromechanical network components Ki are selected and an efficient, energy-economical guidance or control scheme is selected, while the mutual influence of the different decisions and selection decisions, which are used for different views in the planning phase, are pursued.

The proposed concept is presented below by means of a practical example of a conveyor belt system 20 for an airport. The conveyor belt system 20 comprises 48 conveyor belt sections (of these, only six belts are considered below). The maximum velocity, acceleration, length and form of each conveyor belt section 20i is determined in advance in a design and configuration file. A further file ‘conveyor.xls’ contains the electromechanical description of each conveyor belt section 20i (such as motor type, starters, drivers, roller diameter, etc.). This Excel file is presented as the basis for preparation in a file ‘parameter_file.txt’ by means of Matlab®. The file ‘parameter_file.txt’ describes the electromechanical system 20 for the power draw computation tool PBW in a text format (for example in ASCII). The software bridge SWB has been developed in order to represent the description of the electromechanical system 20 in commands for the power draw computation tool PBW in order to construct the model.

FIG. 10 shows a course of a method 100 for planning a power distribution network EVN. An exemplary embodiment provides for the dimensioning, planning and optimization of a power distribution network EVN to be effected by means of the method 100 according to the invention in the following steps:

In a first step 110 (production of the first mechanical load profiles), the conveyor belt system 20 is simulated by means of the load computation tool LBW for one day (that is to say over 86 400 seconds) in order to produce the primary mechanical load profiles Li. The result of the simulation is a mechanical load profile Li for each conveyor belt section 20i. The mechanical load profile Li is stored in an Excel table ‘load_profile.xls’ in which the load, velocity and acceleration are recorded as a function of time t. In order to ascertain the power draw of a particular conveyor belt section 20i, the relevant mechanical load profile Li is fed to the power draw computation tool PBW in a predetermined format. The software bridge SWB splits the file ‘load_profile.txt’ into mechanical load profile elements if the magnitude of the mechanical load profile Li is larger than the power draw computation tool PBW can accommodate. The same process is repeated for the following two scenarios SW, SNW: normal working days and non-working days.

In a second step 120 (ascertainment of the power draw), the power draw computation tool PBW is repeatedly called in order to take the mechanical load profile Li and an electromechanical model of the corresponding installation part Mi as a basis for ascertaining the power draw Pi of each conveyor belt section 20i that has been fed to the conveyor belt section 20i. If many calls are made for the same conveyor belt section 20i (if the power profile is large), the same file ‘parameter_file.txt’ is used. Thus, the same model is used again in the power draw computation tool PBW without it having to be constructed again for this purpose. However, in this case, a new file ‘subload_profile.txt’ is provided upon every call until the entire file ‘load_profile.txt’ for the relevant conveyor belt section 20i has been processed completely by means of the power draw computation tool PBW. After each call, the power draw computation tool PBW produces an output file ‘subload_pow.doc’ that contains the power draw besides other information. The ascertained power draw Pi is then stored in Excel files ‘load_pow.xls’ by means of the software bridge SWB in order to prepare the power profiles Pi for the network dimensioning tool NDW. The process is repeated for all the conveyor belt sections 20i.

A further interface SSP has been developed in order to automate and simplify the communication and the data interchange between the power draw computation tool PBW and the software bridge SWB. At the end of this step 120, a single table TPi (matrix) is produced in the software bridge SWB for each conveyor belt section 20i. A first column of the table TPi contains the ascertained powers Pi for each power profile element, while the second column contains the corresponding period of time for each power profile element. This table TPI is referred to as a power/time matrix. The same process is repeated for working days SW and for non-working days SNW.

In a third step 130 (creation of a network plan), a network plan is created for the power distribution network EVN. Some or all of this step 130 can also take place before the first 110 or the second 120 step.

In a fourth step 140 (preparation of power profiles), for each conveyor belt section 20i of the conveyor belt system 20, the power vectors PVi averaged over 15 minutes are first of all prepared and then combined in order to obtain a single power vector PV20 (i.e. an averaged power profile over 15-minute periods of time) for the entire conveyor belt system 20. Besides the averaged power vectors PVi over 15-minute periods of time, a power vector PVimax is also produced over 15-minute periods of time for the maximum power P20 of the entire conveyor belt system 20. The same process is repeated for a scenario SW for a normal working day and for a scenario SNW for a non-working day. The power vectors LVi, LVimax for average and maximum powers (for real and apparent powers in each case) over 15-minute periods of time Tj represent the power draw Pi of the final or destination nodes Mi in the power distribution network EVN. They are computed for two scenarios SW, SWN, specifically for a working day and a non-working day.

In a fifth step 150 (dimensioning and optimization of the power distribution network EVN), the power profiles Pi in 15-minute steps are fed to the network dimensioning tool NDW in order to create an inexpensive and reliable solution for the intended power distribution network EVN. The simulated power profiles Pi therefore replace the conventional method of estimation of the loads Li in the power distribution network EVN. On the basis of these power profiles Pi, the network dimensioning tool NDW automatically computes everything that a network planner needs on the basis of his guidelines (for example according to IEC standards). This also encompasses flow of power, short-circuit current, energy budget and voltage drops. It also selects the required network components Ki, which comprise: switchgear, safety devices, cables and busbars and also feed sources (transformers and generators).

Although the invention has been illustrated and described in more detail using the preferred exemplary embodiment, the invention is not restricted by the disclosed examples. Other variations can be derived therefrom by a person skilled in the art without departing from the scope of protection of the invention.

The invention provides the following method and the following tool.

For the purpose of planning a power distribution network for an installation having a multiplicity of power consumers, a method comprises the following steps: creation of time-dependent load profiles for the power consumers, creation of time-dependent power profiles for the power consumers, creation of a network plan for the power distribution network, computation of a time-dependent power profile for the installation and dimensioning of network components of the power distribution network taking account of the computed time-dependent power demands on the network components.

The tool for planning a power distribution network comprises the following components: a load computation tool for producing load profiles for the power consumers, a power draw computation tool for producing time-dependent power profiles for the power consumers and a power profile for the installation and a network dimensioning tool for dimensioning and selecting network components of the power distribution network.

### LIST OF REFERENCE SYMBOLS

10 Tool
20 Installation; transport installation
20i Installation part; i-th conveyor belt
20j Installation part; j-th conveyor belt
100 Method
110 Ascertainment of time-dependent mechanical load profiles
120 Ascertainment of time-dependent power profiles
130 Creation of a network plan
140 Computation of a time-dependent power profile for the installation
150 Dimensioning and optimization of network components of the power distribution network
AK Outlay criterion
AR Drive roller
BP People to be conveyed
DFBW Input file for power draw computation tool
DLBW Input file for load computation tool
DPBW Input file for power computation tool
Ei Feed location
EMDM Electromechanical digital model
EVN Power distribution network
FG Conveyable articles
FGT Conveyable article carrier
GT Gearbox part
Ki Network component
LBW Load computation tool
L Rotor
Li Mechanical load profile
LKD Digital model of the installation
LPBW Load and power draw computation tool
Mi Electrical consumer; electric motor
NDW Network dimensioning tool
PBW Power draw computation tool
Ki Network components
I Index of a belt section
Ii Further information
Pi Power profile of an i-th belt section 20i
Pj Power profile of a j-th belt section 20j
Pimin Lower limit of the power requirement
Pimax Upper limit of the power requirement
PK20 Power curve of the installation
P20 Power profile of the installation
P20m Averaged power profile of the installation
P20max Maximum power profile of the installation
PK20 Characteristic of the power draw of the installation over time
PVi Averaged power vector
PVimax Power vector for maximum power
PV20 Power vector for conveyor belt
r Subprofile index for power subprofile of a belt section i
R Upper limit of a subprofile index r for power subprofiles of a belt section i
S Upper limit of the belt section index
NKj Network configuration
NP Network plan
N Upper limit of the quarter-of-an-hour timing index
SNW Consumption scenario for non-working day
SSP Interface between software bridge and power computation tool
SPN Interface between power computation tool and network
SW Consumption scenario for working day
SWB Software bridge
SZi Safety margin
Tj 15-minute time interval
TPI Power table

1.-8. (canceled)

9. A method for planning a power distribution network for an installation having a multiplicity of power consumers, comprising the steps of:
a) creating time-dependent load profiles for the power consumers as a function of a change, over time, in inertial masses to be speeded up, slowed down and/or kept in motion using the power consumers;
b) creating time-dependent power profiles for the power consumers;
c) creating of a network plan for the power distribution network;
d) computing a time-dependent power profile for the installation; and
e) dimensioning of network components of the power distribution network as a function of the computed time-dependent power demands on the network components.

10. The method of claim 1, further comprising repeating a sequence of the steps a) to d) for at least two different consumption scenarios, and taking into account the results for the different consumption scenarios in the step e) of dimensioning the network components.

11. The method of claim 1, further comprising repeating a sequence of the steps a) to e) for at least two different network configurations, and selecting one of these network configurations on the basis of an outlay criterion.

12. The method of claim 1, further comprising considering safety margins for the dimensioning of the network components.

13. The method of claim 1, wherein the power profiles Pi are augmented with information about powers, short circuit current levels, energy budgets and/or voltage drops.

14. A tool for planning a power distribution network for an installation having a multiplicity of power consumers, comprising:
a load computation tool for producing load profiles for the power consumers as a function of a change, over time, in inertial masses to be speeded up, slowed down and/or kept in motion using the power consumers;
a power draw computation tool for producing time-dependent power profiles for the power consumers and a power profile for the installation; and
a network dimensioning tool for dimensioning and selecting network components of the power distribution network.

15. The tool of claim 14, further comprising an interface converter for matching an interface protocol of the load computation tool to an interface protocol of the power draw computation tool.

16. The tool of claim 15, wherein the interface converter is configured to split load profiles so as to meet input interface demands from the power draw computation tool.
